(19) United States
(12) Patent Application Publication
(10) Pub. No.: US 2003/0038834 A1
(43) Pub. Date: Feb. 27, 2003

(54) Graphical download and upload of computer information

(75) Inventors: Sayling Wen, (US); Kuang Shin Lin, Nan Kai District (TW); Xue-Wu Wang, Nai Kai District (TW)

Correspondence Address: Mitchell P. Brook, Baker & McKenzie, 12th Floor, 101 West Broadway, San Deigo, CA, 92101-3890, US

(73) Assignee: Inventec Corporation

(21) Appl. No.: 09/938,912

(22) Filed: Aug. 24, 2001

(51) Int. Cl. G09G 5/00; G06F 15/16

(52) U.S. Cl. 345/738; 345/748; 709/219

(57) ABSTRACT

An information access processing system for graphical download and upload access of a computer running an application software program by a user under a host operating system is disclosed. The information access processing system comprises a front-end unit and a back-end unit. The front-end unit comprises a user interface for interfacing the user to the computer, and the back-end unit comprises an object analyzer. The object analyzer receives information access requests requesting for information as issued by the user for determining the category of information object to be accessed. The object analyzer determines the accessed category of information objects by organizing the objects of the requested category and presenting the organized objects for selection by the user.

### FIELD OF THE INVENTION

This invention relates in general to information input and output for computers and, in particular, to a graphical interface system for conducting information download into and upload from a computer system.

### BACKGROUND OF THE INVENTION

Conventional operating systems (OS) for personal computers (PC) such as commercial Microsoft Windows and freeware Linux are in general full-fledged operating systems capable of many and various functionalities. Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look and feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

### SUMMARY OF THE INVENTION

An easy-to-use application software system aimed at providing hands-on experience and initiating the learning of computer use for computer novices has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting over the network, and access to the popular World Wide Web over the Internet. The system also provides easy-to-use application systems for convenient learning and recreational sessions such as tutoring for personal skills such as language and typing, game playing, as well as audio and video playback.

The present invention provides a system for graphical download and upload of information for a software application system that works in a cooperative manner with a normal full-feature OS in order to provide user friendliness and an encouraging mood for computer novices or even illiterates.

A user attempting to implement computer information download and upload has to interface with the computer application software performing these jobs. This is true regardless of the type of the source and destination for the download and upload respectively. These information sources and destinations constitute sufficient barrier to shy away an inexperienced computer user from computer use either they are remote web sites or local mass storage compact disc sources/destinations.

Typically, the download may involve retrieving information from remote sources such as web sites residing over the World Wide Web, and the upload may involve sending data to third parties such as mail messages and/or documents to 10 other persons via the Internet. Most frequently, application software programs for such tasks require user interactions in a series of steps involving message dialogs based on texts. These interfaces require a certain knowledge level in computers. For experienced computer users, these seldom constitute noticeable trouble, but for computer novices, these are significant hindrance.

It is therefore an objective of the present invention to provide a graphical interface system for computer users to perform information download and upload that is intuitive and simple with automatically organized information.

It is another objective of the present invention to provide a graphical interface system for computer users to perform information download and upload that is intuitive and simple without the need to deal with text-based abstract dialog sessions.

The present invention achieves the above-identified objectives by providing an information access processing system for graphical download and upload access of a computer running an application software program by a user under a host operating system. The information access processing system comprises a front-end unit and a back-end unit. The front-end unit comprises a user interface for interfacing the user to the computer, and the back-end unit comprises an object analyzer. The object analyzer receives information access requests requesting for information as issued by the user for determining the category of information object to be accessed. The object analyzer determines the accessed category of information objects by organizing the objects of the requested category and presenting the organized objects for selection by the user.

In a computer running an application software program by a user under a host operating system, the application software program comprises a front-end unit that comprises a user interface for interfacing the user to the computer and a back-end unit that comprises an object analyzer, the invention further provides a method of processing information access for graphical download and upload access of information comprising the following steps: a) The object analyzer receives the information access requests requesting for information as issued by the user for determining the category of information object to be accessed. b) The object analyzer determines the accessed category of information objects by organizing the objects of the requested category. And, c) The object analyzer presents the organized objects for selection by the user.

### BRIEF DESCRIPTION OF THE DRAWINGS

Other objects, features, and advantages of this invention will become apparent by way of the following detailed description of the preferred but non-limiting embodiments. The description is made with reference to the accompanying drawings in which:

FIG. 1 is a block diagram illustrating the system configuration of a software system for graphical download and upload of information in accordance with a preferred embodiment of the invention;

FIG. 2 is a flowchart illustrating the processing of the graphical download and upload of information in a software system of the invention;

FIG. 3 is a flowchart illustrating the program flow of the software system of FIG. 1;

FIG. 4 is a functional block diagram illustrating the data flow in the software system of the graphical download and upload system of the invention;

FIG. 5 outlines tables for the database structure for information download and upload accesses involved in the operation of the software system of the invention;

FIG. 6 outlines tables for the database index system in an embodiment of the invention;

FIG. 7 is a screen shot of an embodiment of the graphical download and upload system of the invention illustrating an information download service as performed by an application software; and

FIG. 8 is a screen shot illustrating a download interface provided to the user in an embodiment of the graphical download and upload system of the invention.

### DESCRIPTION OF THE PREFERRED EMBODIMENTS

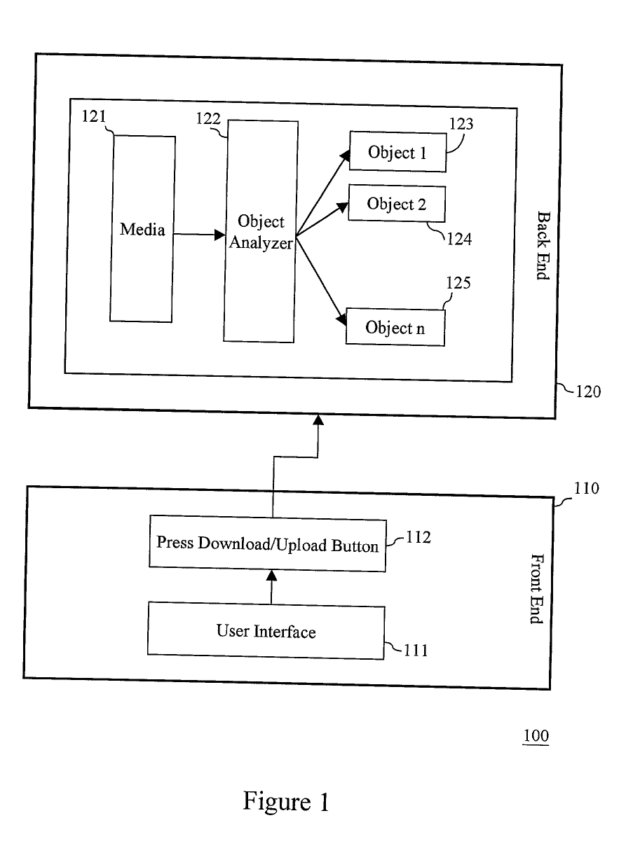

FIG. 1 is a block diagram illustrating the system configuration of a software system for implementing graphical download and upload of information in accordance with a preferred embodiment of the invention. As is illustrated, the software system 100 comprises a front-end unit and a back-end unit, generally identified by reference numerals 110 and 120 respectively.

A user not shown in the drawing accesses the computer information services provided by the software application system 100, a One-Touch OS™ for example, at the front end 110 of the system via a user interface 111 that comprises, for example, display and input devices. All the user's access requests at the front end 110 are relayed to the back end 120 of the software system 100 for processing.

A software application system such as the One-Touch OS™ provides functionalities more than computer information message access services, either electronic mail send/receive and facsimile services. A user-friendly application software program such as the One-Touch OS™ aimed at providing convenience to computer novice users most likely provides other daily-life convenience applications such as Web browsing, recreations, entertaining and so on. This invention, however, concentrates on the access services for computer information messages, in particular, the sending and receiving of electronic mails.

The One-Touch OS™ is a user-friendly and easy-to-use software application program for the convenience of computer novices. The basic software design idea of the One-Touch OS™, as the name implies, is one-touch actuation of software functionalities. Such simple actuation interface is preferred by the majority of computer novice users. The one-touch actuation can be the single-press of a key on the keyboard of the computer. In an example of such an easy-to-use One-Touch OS™ application software, different sets of suitable keys of the keyboard can be assigned for different functionalities of the particular computer application. The principle for these key assignments is simplicity and clarity for computer novices.

An example of such a One-Touch OS™ features many daily-life computer applications aimed at providing hands-on experience and initiating the learning of computer use for computer novices. It has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

In FIG. 1, the user of the software system 100 may implement his or her access via the keyboard of the computer hosting the software system. In the process of information download and upload sessions, the user may press corresponding actuation keys on the computer keyboard assigned for such accesses in a software system such as the One-Touch OS™ described above.

User's request for graphical download or upload of information as issued over the user interface 1 11 by the user at the front-end unit 1 10 of the system can be relayed into the back-end unit 120 for processing. The back-end unit 120, as is illustrated, comprises an object analyzer 122. Based on the user's request, objects representing the requested information originating from various types of media 121 of the system are analyzed by the object analyzer 122. All objects are analyzed and grouped into different categories of objects based on pre-determined classification standards. As a result, objects of requested information are grouped as Objects 1, 2, . . . , n as are represented by reference numeral 123, 124, ..., 125 respectively.

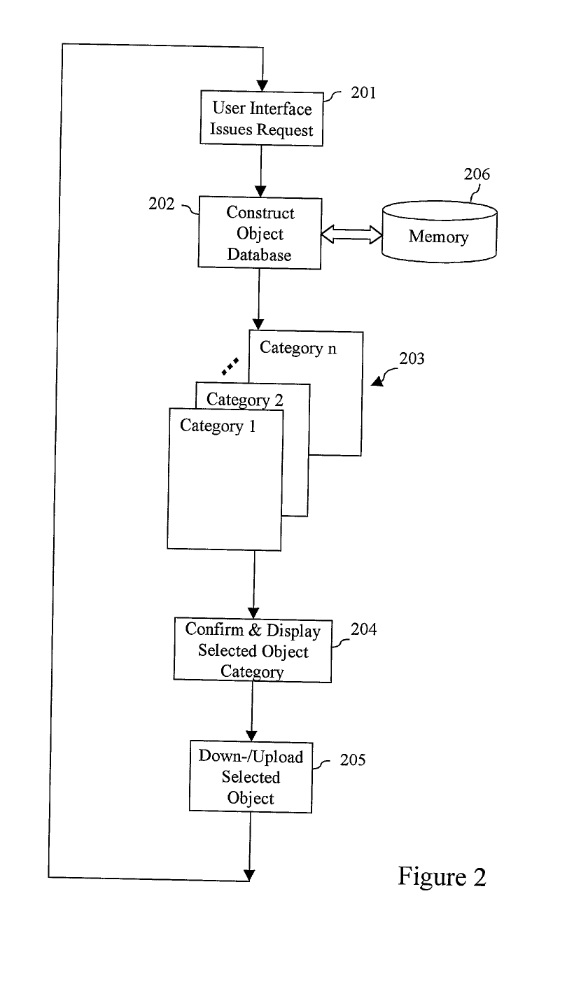

FIG. 2 is a flowchart illustrating the processing of the graphical download and upload of information in a software system of the invention such as outlined in FIG. 1. The graphical download and upload of information is started by the user at step 201 where the user issues request via the user interface, and the software system, in response, constructs an object database at step 202. This can be achieved by the object analyzer 122 of the system 100 of FIG. 1.

The Object database is constructed based on the user's request for either the download or the upload of information via the specific information medium. As is schematically illustrated in the flowchart, the object database thus constructed is stored temporarily in a memory at step 206 in the form of organized and management manner.

Then, at step 203, the selection of the specific category of objects to download or upload is conducted in the object database among a number of categories 1, 2, . . . , n for the information. As the user selection of a specific category of object is confirmed at step 204, the specific category of object is then displayed to the user by the user interface. Then, at step 205, as one or more objects of that specific category are selected from among the presented group, the selection is either downloaded or uploaded as per the user's request. After the completion of download/upload at step 205, the process returns to step 201 to await for the processing of the user's subsequent information download/upload request.

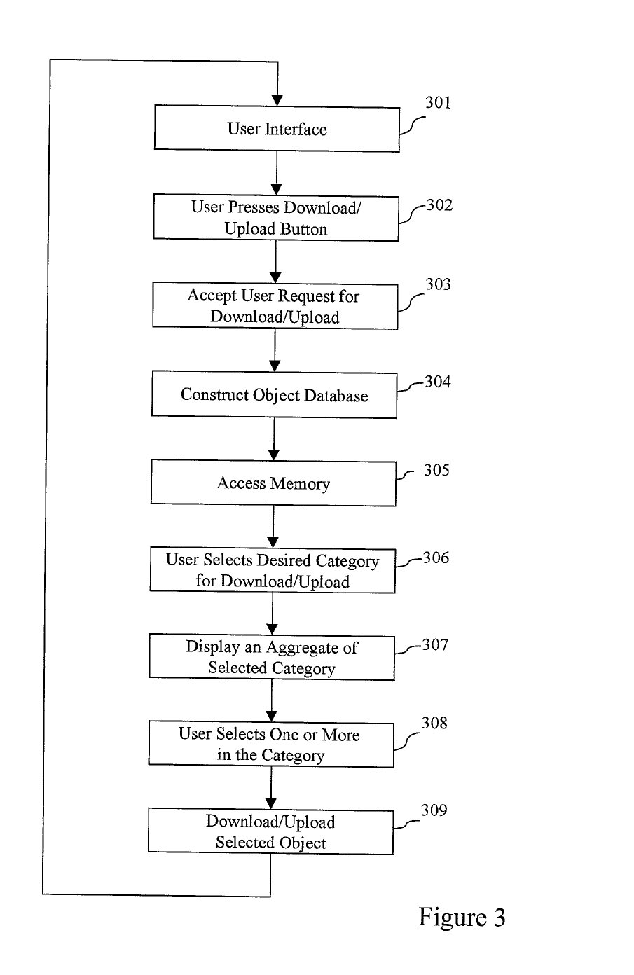

FIG. 3 is a procedural flowchart illustrating the program flow of the software system of FIG. 1. At step 301, the process starts, allowing a user of the software system 100 of FIG. 1 to issue an information download or upload request. As is known, the user of the software system 100 of FIG. 1 may issue such a request by interfacing with the system via the user interface 111 at the front-end unit 110. Such may include the pressing of a virtual push button displayed on the computer screen by the user, such as in a One-Touch OS™ and as is illustrated at step 302.

Then, at step 303, the back-end unit 120 of the system 100 receives the user's request for the download or upload of an information object. Based on this request, an object database is constructed in step 304 based on the particular request of the user's. The constructed database, at this instant, is stored temporarily, as is illustrated in step 305, in a memory.

At this moment, step 306, the user is able to select from within the database, the specific category of information objects desired for download or upload. Once the desired category is identified, at step 307, a group of the particular category of information objects are then displayed for user's selection. At step 308, the user implements his or her specific selection of the desired objects. The selection is for either download or upload at step 309. As the download or upload of information objects is concluded, the process returns back to step 301 to wait for the next cycle of procedural steps.

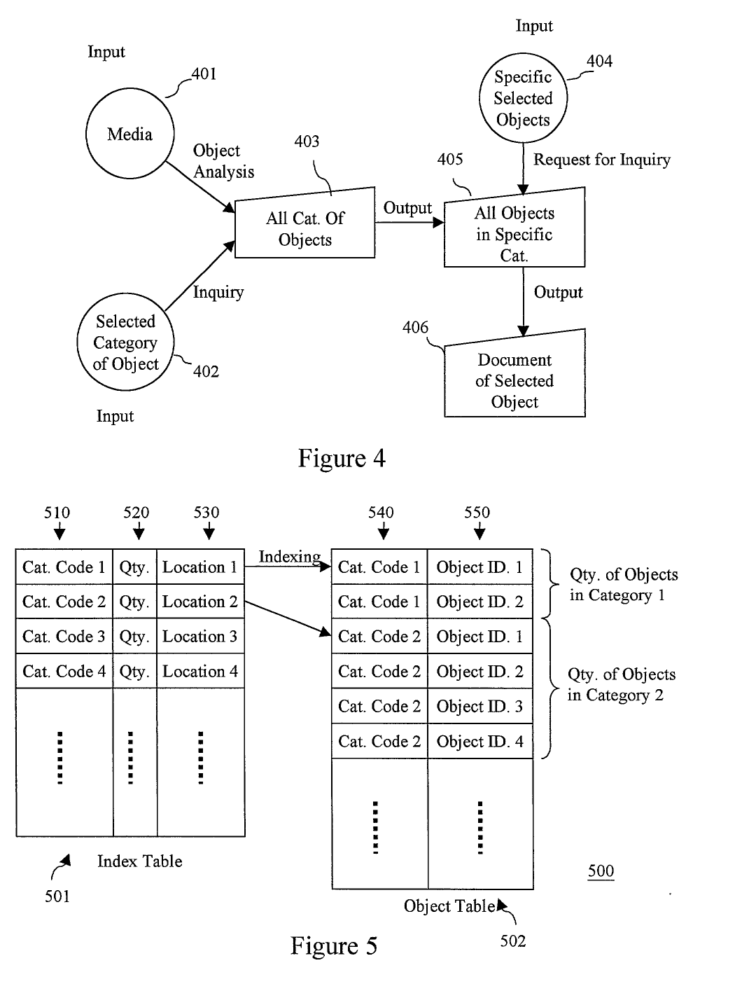

FIG. 4 is a functional block diagram schematically illustrating the data flow in the software system of the graphical download and upload system of the invention. When the user requests for information download from or upload to a medium source, as is schematically shown by the type of input source of 401, all objects in the specific type of designated medium will be output after analysis at 403. On the other hand, if the user requests for certain category of objects, as signified by the type of input source of 402, all objects in the specific category will be output after analysis at 403 likewise. Then, at 405, objects of that particular category are produced for output. With the third type of input, the type 404 in the drawing, when the user specifically designates certain object, a request for inquiry is issued and the system outputs the specific document for that particular request, as signified by the output of that document at 406.

FIG. 5 outlines tables for the database index and database information for implementing information download and upload accesses involved in the operation of the software system of the invention. A typical index system 500 for the object database constructed for the software system of the invention comprises an index table 501 and an object table 502. Each record in the index table 501 comprises at least three fields. They include a category code field, a quantity field, and a location field, as identified by fields 510, 520 and 530 respectively.

In each record of the index table 501, the category code field 510 represents the encoding representation for an object in the database. The quantity field 520 is used to keep track of the total number of that object in a particular category. The location field 530 is used to indicate the specific location of that record in the object table 502. In other words, content of this location field 530 of a record is used for “index-pointing” into the object table 502 where the first of the particular category of objects can be found. Based on the information in the quantity field 520, all objects of the same category can thus be located and accessed when necessary.

An embodiment of the object table 502, as is outlined in FIG. 5, has each of its records comprises at least two fields. The first is the category code field 540 and the second is the object ID field 550. Category code field 540 is used to keep track of the category type of the object recorded in this database. On the other hand, the second field, the object ID field 550 as is shown in FIG. 5, is used to specifically record details of one object of a particular category.

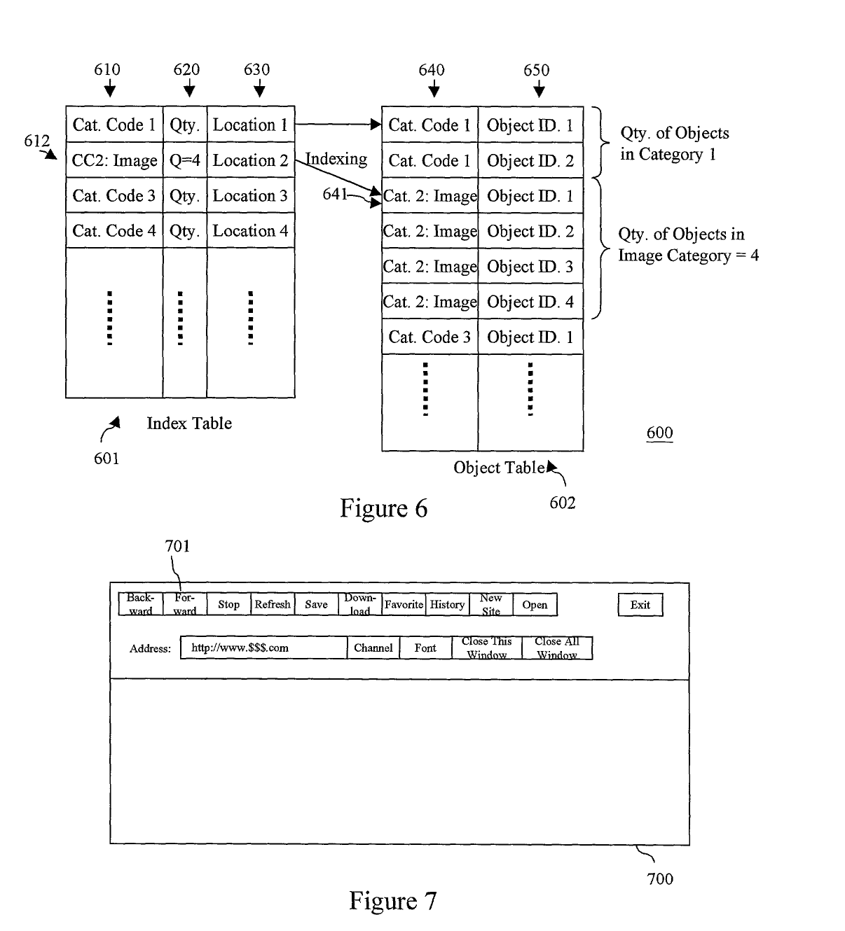

FIG. 6 outlines tables for the database index system 600 in an embodiment of the invention. In this described embodiment, assume a user is accessing the download service in a web browser application in which he or she intends to implement a download operation. A server, responding to the user's request, constructs a text-based database that lists all the hyperlink texts in a text string constructed via a scanning of the HTML page in the specific web site. In other words, the text-based database with a text string containing all the links in the web page is reflected in the database such as is outlined in FIG. 6.

FIG. 7 is a screen shot of an embodiment of the graphical download and upload system of the invention illustrating an example of information download service as performed by an application software. As is seen in the screen shot, the display 700 offers a one-touch actuation system such as provided by the One-Touch OS™ software system that provides an easy-to-use and intuitive interface for a computer novice to implement graphical information download and upload sessions on a computer. A series of, for example, ten one-key actuation hotkey assignments generally identified by reference numeral 701 provide such simple functionality in the process of web access for the desired information.

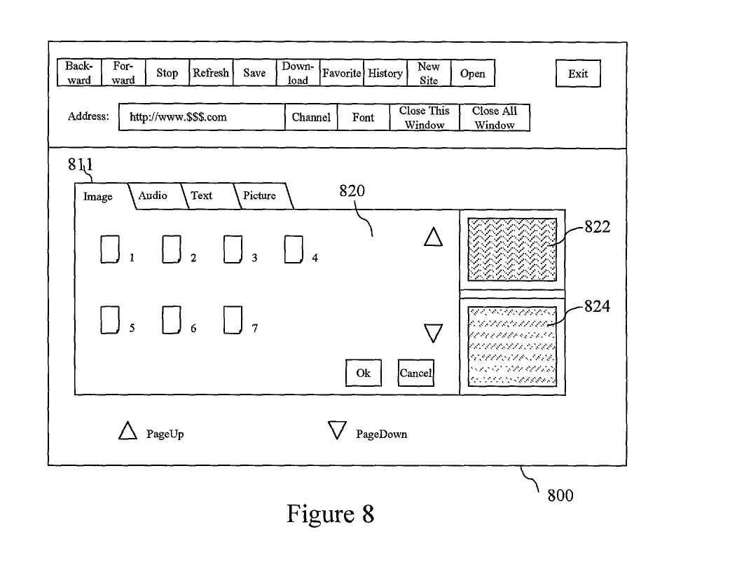

An example of a screen shot of corresponding access display for the user is outlined in FIG. 8. This display screen 800 offers the user with an opportunity to implement his or her selection of the particular category of objects desired.

As is outlined in FIG. 6, and with reference simultaneously to FIG. 8, the second category of objects, namely the very category of image objects as is outlined in the second record 612 in field 610 in the index table 601, is index-pointed to the specific location in the object table 602. At the pointed location, that is, starting at the first location 641, a total of four, as is specified by the second, the quantity, field 620 in record 612 (Qty.=4), are recorded in the object table 602. In other words, four image objects are in the image category of objects, according to the index system 600 of FIG. 6.

FIG. 8 is a screen shot illustrating a download interface provided to the user in an embodiment of the graphical download and upload system of the invention. In the exemplified screen display 800 for a user of the software system, the user is provided with the interface for selection of download information.

In the screen, as the user selects the desired category of image, either via hotkey assignment or via tab selection at the tab 811, all objects in the selected category for download operation are shown in the display area 820 of the screen. In the case of images and pictures, a preview of the image or picture as pointed by the user can be seen in the preview area 822. All those objects selected by the user can be listed in the select list area 824.

A likely scenario of application of the graphical download and upload system of the invention involves the access of information from a CD-ROM by a user. As the user issues the request indicating the desire to access information objects from a CD-ROM disc, information from that particular disc is first read by the system and analyzed. The information is sent for analysis and the result is sent to a memory where the category database is kept for user's selection. As the user accesses the CD-ROM based on the organized category of information objects, selected categories of objects may then be downloaded in a process similar to the one described with reference to FIG. 8.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An information access processing system for graphical download and upload access of a computer running an application software program by a user under a host operating system, said information access processing system comprising:
a front-end unit comprising a user interface for interfacing said user to said computer; and
a back-end unit comprising an object analyzer wherein
said object analyzer receiving information access requests requesting for information as issued by said user for determining the category of information object to be accessed; said object analyzer determining said accessed category of information objects by organizing said objects of said requested category and presenting said organized objects for selection by said user.

2. The information access processing system of claim 1, wherein said object analyzer organizes said objects of said request category by constructing a database, said database comprising an index system for organizing said objects.

3. The information access processing system of claim 1, wherein said application software program is a user-friendly application software system incorporating a plurality of simple interfaces for intuitive access by computer users.

4. The information access processing system of claim 1, wherein said application software program is a user-friendly One-Touch OS application software system for processing daily-life computer applications for computer users.

5. The information access processing system of claim 4, wherein said One-Touch OS application software system processes handy personal information including phone numbers and addresses.

6. The information access processing system of claim 4, wherein said One-Touch OS application software system takes notes.

7. The information access processing system of claim 4, wherein said One-Touch OS application software system provides communication services.

8. The information access processing system of claim 4, wherein said One-Touch OS application software system provides chatting service over the Internet.

9. The information access processing system of claim 4, wherein said One-Touch OS application software system provides access to the World Wide Web over Internet.

10. The information access processing system of claim 4, wherein said One-Touch OS application software system provides language tutoring to computer users.

11. The information aceess processing system of claim 4, wherein said One-Touch OS application software system provides typing tutoring to computer users.

12. The information access processing system of claim 4, wherein said One-Touch OS application software system provides game playing to computer users.

13. The information access processing system of claim 4, wherein said One-Touch OS application software system provides multimedia playback.

14. The information access processing system of claim 4, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring to computer users, providing game play to computer users, and providing audio and video playback.

15. An information access processing system for graphical download and upload access of a computer running an application software program by a user under a host operating system, said information access processing system comprising:
a front-end unit comprising a user interface for interfacing said user to said computer; and
a back-end unit comprising an object analyzer wherein
said object analyzer receiving information access requests requesting for information as issued by said user for determining the category of information object to be accessed; said object analyzer determining said accessed category of information objects by organizing said objects of said requested category by constructing a database wherein said database comprising an index system for organizing said objects, and said object analyzer presenting said organized objects for selection by said user.

16. The information access processing system of claim 15, wherein said application software program is a user-friendly application software system incorporating a plurality of simple interfaces for intuitive access by computer users.

17. In a computer running an application software program by a user under a host operating system, said application software program comprising a front-end unit that comprises a user interface for interfacing said user to said computer and a back-end unit that comprises an object analyzer, a method of processing information access for graphical download and upload access of information comprising the steps of:
a) said object analyzer receiving said information access requests requesting for information as issued by said user for determining the category of information object to be accessed;
b) said object analyzer determining said accessed category of information objects by organizing said objects of said requested category; and
c) said object analyzer presenting said organized objects for selection by said user.

18. The method of processing information access of claim 17, wherein said application software program is a user-friendly application software system incorporating a plurality of simple interfaces for intuitive access by computer users.

19. The method of processing information access of claim 18, wherein said application software program is a user-friendly One-Touch OS application software system for processing daily-life computer applications for computer users.

20. The method of processing information access of claim 18, wherein said One-Touch OS application software system processes handy personal information including phone numbers and addresses.

21. The method of processing information access of claim 18, wherein said One-Touch OS application software system takes notes.

22. The method of processing information access of claim 18, wherein said One-Touch OS application software system provides communication services.

23. The method of processing information access of claim 18, wherein said One-Touch OS application software system provides chatting service over the Internet.

24. The method of processing information access of claim 18, wherein said One-Touch OS application software system provides access to the World Wide Web over Internet.

25. The method of processing information access of claim 18, wherein said One-Touch OS application software system provides language tutoring to computer users.

26. The method of processing information access of claim 18, wherein said One-Touch OS application software system provides typing tutoring to computer users.

27. The method of processing information access of claim 18, wherein said One-Touch OS application software system provides game playing to computer users.

28. The method of processing information access of claim 18, wherein said One-Touch OS application software system provides multimedia playback.

29. The method of processing information access of claim 19, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring, providing game playing, and providing audio and video playback.
